(19) United States
(12) Patent Application Publication
(10) Pub. No.: US 2013/0132032 A1
(43) Pub. Date: May 23, 2013

(54) SYSTEM, DEVICE AND ASSOCIATED METHODS FOR MONITORING A PHYSICAL CONDITION OR OPERATING PERFORMANCE OF A STRUCTURE

(71) Applicant: Berin McKeown, Carmel, IN (US)

(72) Inventor: Berin McKeown, Carmel, IN (US)

(21) Appl. No.: 12/935,625

(22) PCT Filed: Mar. 31, 2009
(86) PCT No.: PCT/US09/38962

§ 371 Date: Jan. 11, 2013

Related U.S. Application Data
(60) Provisional application No. 61/040,930, filed on Mar. 31, 2008.

(51) Int. Cl. G06F 17/00

(52) U.S. Cl. CPC G06F 17/00
USPC 702/182

(57) ABSTRACT

A system for monitoring a structure is provided. The system comprises at least one sensor node attachable to a structure and configured to monitor a physical condition or operating performance that is being exhibited by the structure; a power source configured to power the at least one sensor node; a converter adapted to receive an analog output signal generated by the at least one sensor node in response to the monitored physical condition or operating performance of the structure and to convert the analog signal into a digital signal; and a processor for receiving the digital signal and processing the digital signal into feedback readable by a user to determine whether the physical condition or operating performance of the structure falls within a predetermined range.

### RELATED APPLICATIONS

This application claims priority to U.S. Provisional Patent Application Ser. No. 61/040,930 filed Mar. 31, 2008, the disclosure of which is expressly incorporated by reference herein.

### FIELD OF THE INVENTION

The present invention relates generally to sensor systems, and specifically to sensor systems that wirelessly collect, store, process and/or output data, particularly data that is related to equipment or structures from which the data is taken.

### BACKGROUND OF THE INVENTION

Modern society relies on the rotating shaft to literally move the world. From conveying to machining applications to global transportation networks, the rotating shaft is a key element to modern day industrial and transportation infrastructure. One issue that society has faced in implementing the rotating shaft to accomplish work, is the ability to mount a tool or an implement on the shaft to accomplish a task. Although the dynamic and static forces exerted by implements on rotating shafts are well understood, skilled expertise and precision manufacturing are ultimately required to mount such implements. For instance, when an implement exerts too much pressure on the shaft, the shaft is prone to premature failure due to fractures in its structure (see, J. Qian and A. Fatemi (1996). “Mixed mode fatigue crack growth: a literature survey”, Engineering Fracture Mechanics, 55, 969-990). Moreover, when an implement does not apply enough force, it comes loose and spins on the shaft, damaging both the shaft and the implement. Several mounting styles have been employed to assist with this phenomenon.

Press-fit mounts are common when utilizing metallic shafts and implements. The implement is constructed in such a way that its interior circumference is slightly less than the circumference of the shaft. The implement is then heated which causes its material to expand while the shaft is cooled causing its material to contract. The implement is slid onto the shaft where both components migrate towards the same temperature. Given the undersized nature of the implement's interior circumference, it applies a pressure to the shaft as it cools and the shaft heats up. This style of mounting is widely considered a superior mechanical bond between shaft and implement, allowing the full load carrying and speed capabilities of the shaft. This mounting style unfortunately suffers from several drawbacks. The tolerances required to manufacture a “ground and polished” shaft to use in a press-fit are on the order of one ten-thousandths of an inch depending upon shaft size, which considerably increases the cost of such shafts and requires special handling and storage to ensure shafts are not damaged. The nature of the mechanical bond is such that it is very difficult to move or remove the implement on the shaft once in place. This is inconvenient as many times a shaft will have several implements attached, some of which will require periodic replacement. Lastly, since the heating and cooling processes are not uniform through the components, such as conducted under laboratory conditions, this type of fit is not an exact science and requires personnel with extensive experience to achieve an optimal mount.

Keyed mounting styles utilize a milled slot in both shaft and implement to mechanically connect the two components. These slots are engaged by a “key” (square bar stock) that acts as a wedge to create an “interference fit”, or friction fit, between implement, key, and shaft. The bond established between shaft and implement is quite strong, but speed and load capabilities of the shaft have to be reduced when compared to a press-fit mount. The tolerances for a shaft utilizing a key mount are less stringent than a press-fit mount and thus a “commercial grade” shaft (at a lower cost) can be employed. This mounting style also suffers from several drawbacks. For example, the process of keying both the shaft and the implement typically causes this mounting style to be more expensive. Moreover, the time and expertise required to join the shaft and implement together with the key can be extensive, thus further increasing the associated costs. Lastly, the key mounting style is prone to stress concentrations in the key slot that can cause catastrophic failure in the shaft or implement (see, D. Sheba and K. Zumbulev (2006). “Sorting out shaft connections”, Machine Design, Vol. 78, no. 21, pages 94-98).

Set screw mounting styles employ a collar or sleeve and a tangential screw that screws radially into the shaft, thus pinning the shaft between collar and screw. This style of mounting is an easy, quick, and cost effective method to attach an implement to a shaft. However, this mode of mounting causes eccentricity in the shaft's rotation and is prone to failure at the set screw. In addition, it has the lowest load and speed capabilities as compared to other mounting styles, and, as a result, the set screw can cause permanent deformation in the shaft necessitating the replacement or repair of the shaft.

Taper lock mounting styles employ a tapered sleeve or other mechanical system to employ a friction fit similar to a press-fit. Taper lock mounts can be installed quickly and have beneficial load and speed capabilities much like press-fit mounts, which have uniform concentricity around the shaft. Additionally, typical taper lock mounting styles have broad fit tolerances due to their sliding tapered designs such that they can be used on commercial grade shafts. However, issues with zeroing out pre-loading and complex mounting instructions make it difficult to know when the mount has been installed correctly. If the taper lock is installed too tightly, it can cause pre-loading in the implement and stress fractures in the shaft leading to premature failure. If the taper lock is installed too loosely or becomes loose, it will rotate on the shaft and cause permanent damage to the implement and shaft. Typically manufacturers of such mounts publish recommended torque values to apply to the mount in order to apply an optimal level of pressure on the shaft. In practice, these recommended values are rarely used at initial install and subsequent inspections, as many maintenance departments lack the personnel time or expertise to properly install the mounts.

Like the rotating shaft, society depends on structures to work and live in, for protection, for transportation (e.g., highways & bridges), and to facilitate collection of raw materials (e.g., underground mines). The design, materials, and building techniques used in structures have dramatically improved over history and have allowed society to build larger, more stable structures. As the industrialized world's infrastructure has grown, society has become dependent on inspectors to monitor and report when repairs are required or when a structure has reached the end of its useful life. The United States, as an example, experienced a dramatic increase in its infrastructure during the 1950s. That infrastructure has aged during the last six decades and inspection resources have been strained in terms of monitoring and assessing the condition of the infrastructure.

Conventional techniques that have been used to monitor structural health include periodic inspections, which utilize portable sensor networks and actuators that provide a one time reading (see, Abudayyeh, O., Abdel-Qader, I, Nabulsi, S., and Weber, J., (2004). “Using Non-Destructive Technologies and Methods in Bridge Management Systems,” The Journal of Urban Technology, 11(1): 63-76). For example, a portable sensor network and/or actuator can monitor the structural health of a sensor equipped bridge as a truck crosses over. Other techniques include invasive procedures such as coring and dyeing. In recent years, structural health monitoring, as a field, has progressed as proposals for sensor networks and prototype designs have been tested (see, Lynch, J. P. and Loh, K. J. (2006). “A Summary Review of Wireless Sensors and Sensor Networks for Structural Health Monitoring,” Shock and Vibration Digest, Sage Publications, 38(2): 91-128). Deployment of such permanent sensor networks have been hampered by high cost (versus manual inspection) and by the inability of the sensor networks to provide continuous feedback due to power constraints.

Measuring stress and temperature in static and dynamic members is a well documented methodology to monitor equipment and structures (see, US Army Corps of Engineers, “Structural Deformation Surveying”). Multiple collecting methodologies exist such as the use of foil gage or piezoelectric strain gages, sonic transducers, or laser telemetry. Each methodology collects strain data and utilizes Young's Modulus to determine the stress in the material per the equation σ=E×ε, where: σ is the stress in axis of interest, E is Young's Modulus and ε is the strain in the axis of interest.

Utilizing tables from finite element modeling, the regional stress in the implement can be translated into pressure applied to the shaft and compared to preset limits as to whether the implement is installed properly. For structures, the stress can be translated into applied load and compared to preset limits as to whether the structure is beyond design capability or experiencing permanent damage as demonstrated by a hysteresis curve that does not retreat to zero strain.

Some ambient conditions can affect the stress reading in a material. Some examples include, thermal energy, which causes metal to expand or contract; moisture, which causes wood to swell or constrict; and water and temperature, which causes concrete to undergo a freeze/thaw cycle. To remove the effect of these ambient conditions, it is necessary to calculate their impact on the local stress, read from the strain gage, and remove that impact for the purposes of comparison to the preset limits as outlined by the equation σₜₑₛₜ=σ_{gage}−σ_{condition}.

The ambient condition stress is determined based upon the ambient condition. In the case of ambient temperature, the stress is calculated by σₜₑₘₚ=E×α×ΔT, where: σ is the stress associated with temperature change, E is Young's Modulus, A is the coefficient of thermal expansion, and ΔT is the difference in temperature.

When structural health monitoring sensor networks were first introduced, the devices utilized power hungry integrated circuits that demanded power sources to generate tens of milliwatts per hour. The typical power source used to operate these monitoring sensor networks were batteries or hard-wired power infrastructure. These devices, however, have suffered from reliability, particularly because the batteries typically require replacement every few months and are unable to continuously stream data regarding the attached implement or structure due to power requirements. Most recently, advances have been made in size and power consumption of electronics deployed as sensor networks (see, J Hill & Etc., “The platforms enabling wireless sensor networks”, J. Hill, M. Horton, R. Kling and L. Krihsnamurthy, (2004), “The Platforms Enabling Wireless Sensor Networks,” Communications of ACM, Vol. 47, No. 6, pg. 41-46). New generations of micro and pico watt processors coupled with ambient power collecting techniques, such as photovoltaic power, have enabled a new generation of low power sensors. Additionally, dramatic improvements have been made in battery technology such that batteries with less than 250 mm³ of volume are able to provide 50 mA hours of power. A technology that holds particular promise is thin film battery technology where the anode and cathode are deposited on a ceramic or plastic substrate at the micro level. This technology is superior as the thin film battery is physically flexible and resilient under outside forces, has a broader operating temperature range, and increased charge density. As battery technology has improved, a combined approach of battery and ambient power collection is a promising method to power a remote sensor on a continual and longer basis. These networks will be capable of meeting power demands by collecting sufficient power from ambient conditions when available and utilizing battery power when ambient power is not available.

There is a need for a device, method, and/or system that is cost effective, low power, collects power from the ambient environment, and notifies a user when an implement has been properly installed to a rotatable shaft and/or notifies a user as to the condition of an implement or structure. The present invention is intended to overcome and improve upon these and other shortcomings of the prior art.

### SUMMARY OF THE INVENTION

The present invention is related to devices, methods and systems for employing non-destructive and non-invasive methodologies to continuously measure physical conditions, such as strain and temperature, on an implement attached to a shaft or a rigid member of a structure. The present invention provides real-time local feedback in the form of a visual display via LED(s) (or OLED/LCD) embedded in the device.

According to one aspect of the present invention, a system for monitoring a structure is provided. The system comprises at least one sensor node attachable to a structure and configured to monitor a physical condition or operating performance that is being exhibited by the structure; a power source configured to power the at least one sensor node; a converter adapted to receive an analog output signal generated by the at least one sensor node in response to the monitored physical condition or operating performance of the structure and to convert the analog signal into a digital signal; and a processor for receiving the digital signal and processing the digital signal into feedback readable by a user to determine whether the physical condition or operating performance of the structure falls within a predetermined range.

According to certain aspects of the present invention, the power source can be selected from at least one of a battery and a capacitor, as well as may be rechargeable.

In specific exemplary embodiments, the power source utilizes a power collecting technique to power the at least one sensor node. According to this aspect of the invention, the power collecting technique is selected from at least one of a piezoelectric material, a coil and permanent magnet, an electromagnetic wave, a thermoelectric device, a pyroelectric device, a photovoltaic system and an air flow system. Moreover, the power collecting technique can include at least one of an electrical power producing material, a rectifier to convert current from AC to DC, a storage circuit to store power, a switching circuit to turn power on and off, and a power regulation circuit to ensure consistent power is delivered to the at least one sensor node.

In certain aspects of the invention, the at least one sensor node includes at least one of a strain gage, a temperature sensor, a thermistor, a thermocouple, an accelerometer, an ultrasound device, a laser, a magnetoelastic device, an electrical induction device, a piezoelectrical device, a fiber optic device, and a nanotube device. Moreover, the at least one sensor node can be configured to measure at least one of strain, temperature, vibration, pressure, torque, angular rotation, bending, tension, and compression.

In further aspects in accordance with the present invention, the converter is an integrated analog digital converter (ADC).

In accordance with still other aspects of the present invention, the system for monitoring the structure may further comprise a memory component, which stores converted sensor data that has been processed by the processor. The memory component may further contain a unique address to identify the sensor data, as well as a database of previously monitored physical conditions or operating performances of the structure to permit comparison of data. In accordance with this specific embodiment, the comparison of data can then be read by the user to determine whether the physical condition or operating performance of the structure falls within the predetermined range.

In certain embodiments, the processor can be adapted to operate in a sleep mode to conserve power. According to various specific embodiments, the sleep mode may be interrupted by receiving sensor data, by being manually activated via a switch or by being remotely activated by a transceiver network.

In accordance with another embodiment of the present invention, the feedback generated by the processor and readable by the user includes a visual indicator, the visual indicator including at least one of a light emitting diode, an LCD, an OLED and a color or shape changing material driven by an electrical signal. In other embodiments, the feedback readable by the user includes an audible indicator, the audible indicator including at least one of a beep, a siren and a whistle, while in other embodiments the feedback readable by the user includes a tactile indicator, the tactile indicator including at least one of a turkey pop-up, a lengthening bar and Braille bumps.

According to another aspect of the present invention, the system for monitoring the structure further comprises a radio transponder that is wirelessly coupled to a base station for transmitting the feedback to one or more remote locations that are accessible by the user. According to this exemplary embodiment, the transmission of feedback includes sending the feedback by a transceiver over a network, such as a satellite network, a cellular network and a radio network. In addition, the one or more remote locations include at least one of an individual workstation, a local area network and the Internet.

In certain aspects of the present invention, the structure includes a rotatable shaft that is attachable to a piece of industrial power transmission equipment, while in other embodiments, the structure includes a rotatable shaft attachable to a wheel hub or drive train.

In still other embodiments, the base station is located in a vehicle.

In yet other embodiments, the structure includes a rigid member of a building or structure, the rigid member of the building or structure including at least one of a steel framed building, a bridge span, and an underground mine support.

In accordance with another aspect of the present invention, a method for monitoring a structure is provided. The method comprises attaching at least one sensor node to a structure; monitoring a physical condition or operating performance that is being exhibited by the structure with the at least one sensor node; powering the at least one sensor node with a power source; generating an analog output signal from the at least one sensor node in response to the monitored physical condition or operating performance of the structure; optionally signal processing the analog signal (e.g., noise or gain); converting the analog output signal into a digital signal; processing the digital signal into feedback readable by a user; and determining whether the physical condition or operating performance of the structure falls within a predetermined range.

### BRIEF DESCRIPTION OF THE DRAWINGS

The above-mentioned aspects of the present teachings and the manner of obtaining them will become more apparent and the teachings will be better understood by reference to the following description of the embodiments taken in conjunction with the accompanying drawings, wherein:

FIG. 1 illustrates an electrical circuit diagram for a first sensor node embodiment in accordance with the teachings of the present invention;

FIG. 2 illustrates an electrical circuit diagram for a second sensor node embodiment in accordance with the teachings of the present invention;

FIG. 3 illustrates an electrical circuit diagram for a power collection circuit embodiment utilizing piezoelectric power gathered from an environment in accordance with the teachings of the present invention;

FIG. 4 illustrates an electrical circuit diagram for a power collection circuit embodiment utilizing inductor based power gathered from an environment in accordance with the teachings of the present invention;

FIG. 5 illustrates an electrical circuit diagram for a power collection circuit embodiment utilizing RFID power gathered from an environment in accordance with the teachings of the present invention;

FIG. 6 illustrates an electrical circuit diagram for a sensor node and base station embodiment in accordance with the teachings of the present invention;

FIG. 7 illustrates an operational schematic for a first sensor node embodiment in accordance with the teachings of the present invention;

FIG. 8 illustrates an operational flowchart for a first sensor node embodiment in accordance with the teachings of the present invention;

FIG. 9 illustrates an operational schematic for a second sensor node embodiment in accordance with the teachings of the present invention;

FIG. 10 illustrates an operational flowchart for a second sensor node embodiment in accordance with the teachings of the present invention;

FIG. 11 illustrates an operational schematic for a sensor node and base station embodiment in accordance with the teachings of the present invention;

FIG. 12 illustrates an operational flowchart for another sensor node and base station embodiment in accordance with the teachings of the present invention;

FIG. 13 depicts a sensor node employed on an automotive wheel hub in accordance with the teachings of the present invention;

FIG. 14 depicts a sensor node employed on a rail wheel hub in accordance with the teachings of the present invention;

FIG. 15 depicts sensor nodes employed on two types of sprockets in accordance with the teachings of the present invention;

FIG. 16 depicts sensor nodes employed on a hub in accordance with the teachings of the present invention;

FIG. 17 depicts sensor nodes employed on a shrink disk in accordance with the teachings of the present invention;

FIG. 18 depicts sensor nodes employed on a bushing in accordance with the teachings of the present invention;

FIG. 19 depicts sensor nodes employed on a bearing in accordance with the teachings of the present invention;

FIG. 20 depicts sensor nodes employed on a bridge span in accordance with the teachings of the present invention;

FIG. 21 depicts sensor nodes employed on underground mine supports in accordance with the teachings of the present invention; and

FIG. 22 depicts sensor nodes employed in building structural members in accordance with the teachings of the present invention.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Before describing in detail the various illustrative embodiments and aspects of the present invention, it should be understood and appreciated herein that the various devices described herein are not intended to function as a “one size fits all” structure. Rather, the disclosed devices are configured such that they may be custom manufactured and configured to adapt to a specific situation, application and/or ambient condition. For instance, an implement used in accordance with the present teachings may be attached to a shaft or structure that only requires stress and/or temperature readings be taken to determine whether it has been properly installed. According to this embodiment, it should be readily understood and appreciated that only a strain gage and temperature sensor need to be implemented to achieve these readings. However, if the industrial application requires the remote monitoring of a load bearing beam's structural health during an application, it might be necessary to incorporate a wireless component (e.g., RFID component), strain gage, temperature sensor and accelerometer. As such, it should be understood that the various embodiments disclosed herein are illustrative only and are not intended to limit the scope and/or application of the present invention and its teachings in any manner.

It should also be appreciated and understood herein that the sensor devices of the present invention can be attached to any known shafts or rigid members of any type of building or physical structure. In certain illustrations discussed herein, the sensors are described as being attachable to steel framed buildings, bridge spans and underground mine supports. However, it should be understood that the disclosed sensor devices can be attached to any known structures to be monitored (e.g., wind generators, towers, bearings) and are not limited in any way to the various structures specifically illustrated herein.

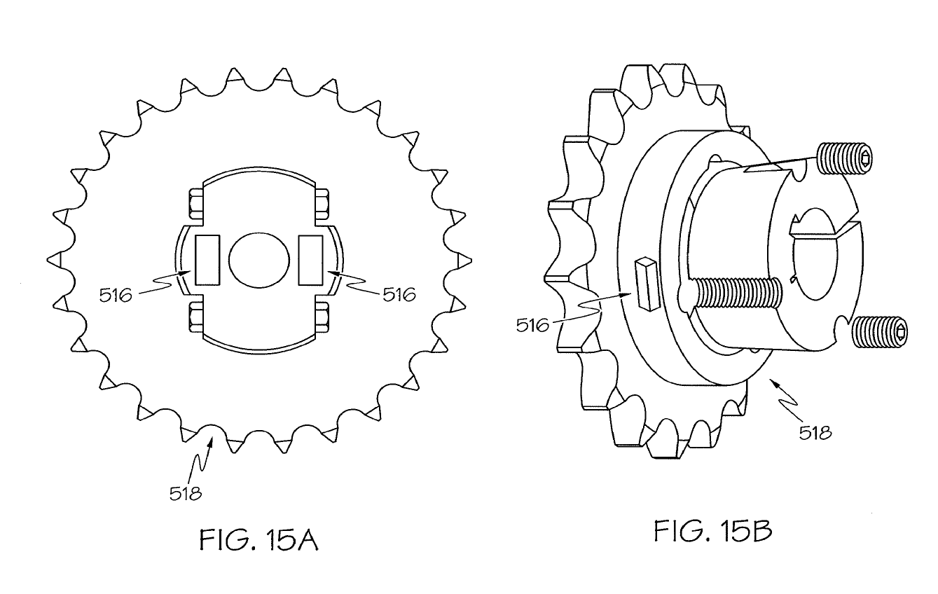

As used herein, the term “implement” includes, but is not limited to, any device or tool that can be used to perform a task and/or application and is attachable to a shaft or a rigid member of a structure. It should also be understood and appreciated herein that the various implements disclosed herein can be used in numerous practical applications without straying from the teachings of the present invention. One such illustrative application in which these implements can be used includes those within the industrial power transmission (IPT) area. Implements in the IPT area include, but are not limited to, bushings, belts, bearings, couplings, hubs, sheaves, sprockets and/or any other power transmission device that is attachable to a shaft or rigid member of a structure. Exemplary illustrations of various implements shown within an IPT application can be seen, for example, within FIGS. 15-18.

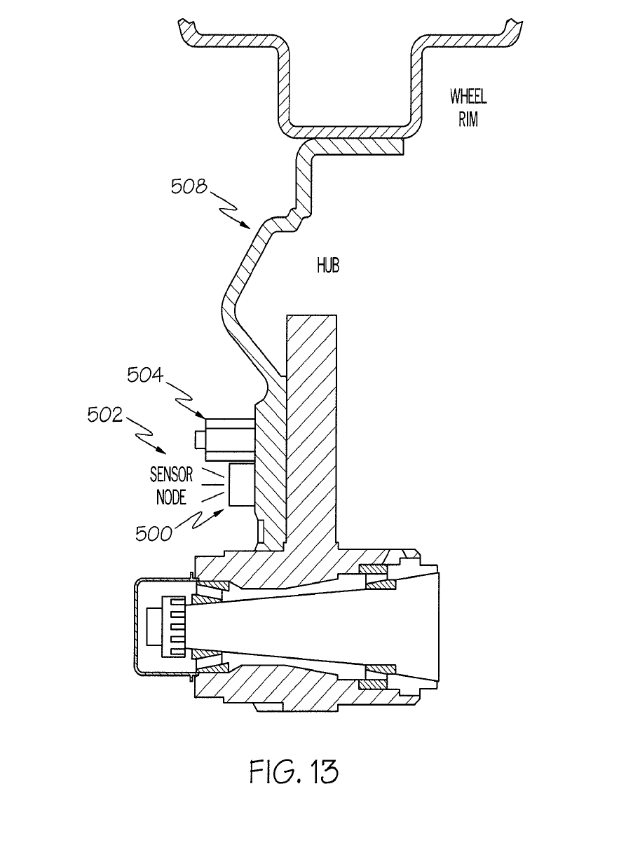

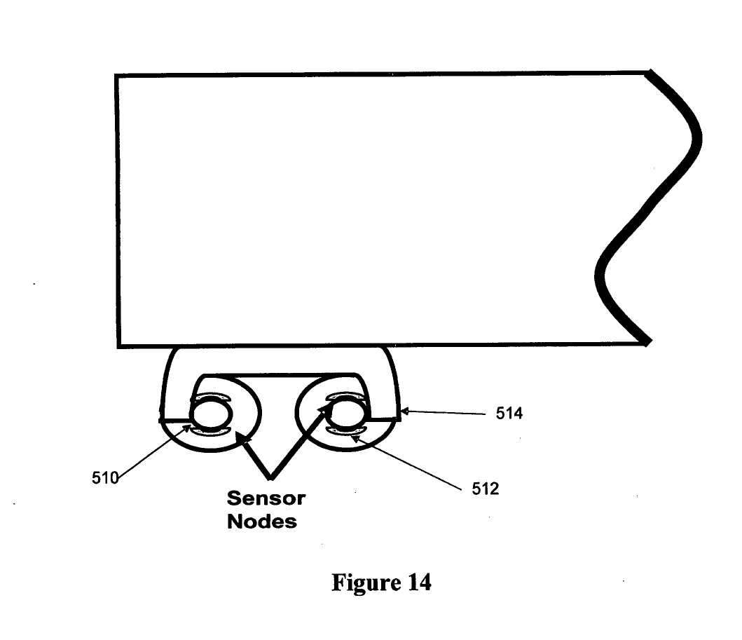

Implements in accordance with the teachings of the present invention may also be used in transportation applications (e.g., rail, automotive, and heavy truck applications) and include, but are not limited to, wheel hub torque and driveshaft applications. Exemplary illustrations of various implements shown within a transportation application can be seen, for example, within FIGS. 13 and 14.

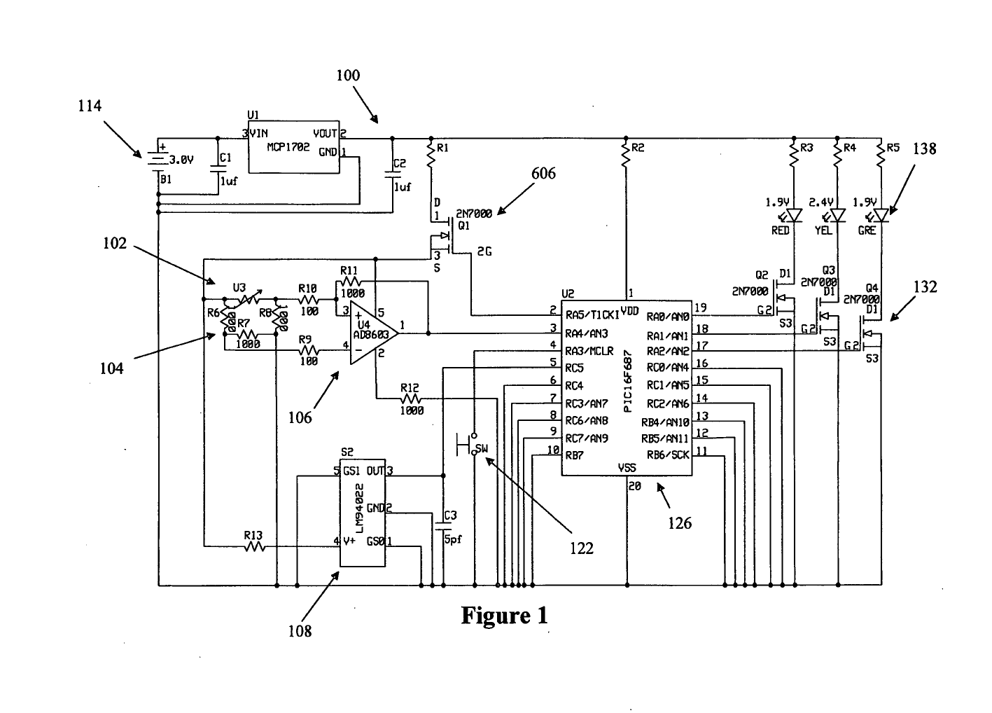

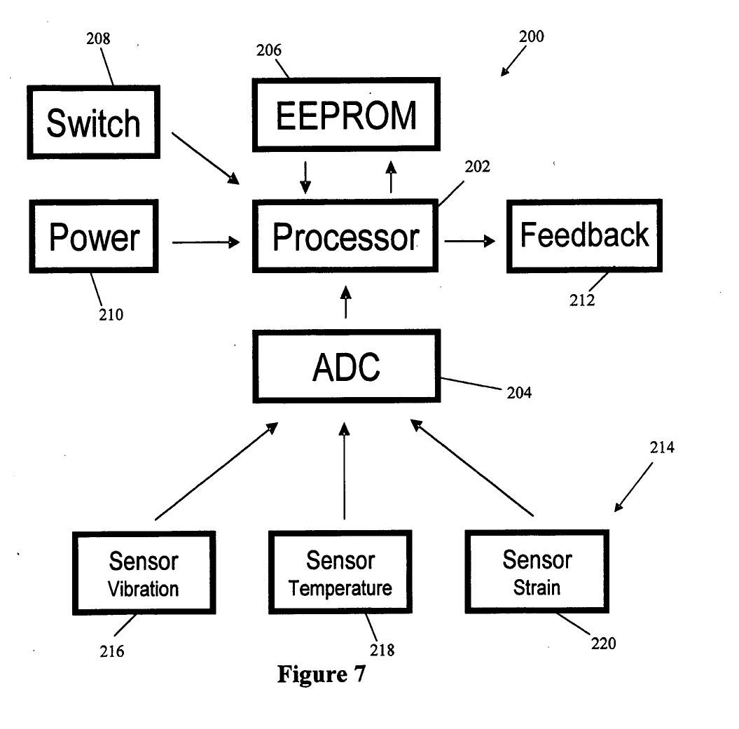

FIG. 1 depicts an electrical circuit diagram 100 for a first sensor node embodiment in accordance with the teachings of the present invention is illustrated. Moreover, FIG. 7 depicts an operational schematic 200 for the first sensor node embodiment. According to this aspect of the present invention, the sensor node includes a processor 202, converter 204 (such as an analog digital converter (ADC)), memory 206 (such as Electrically Erasable Programmable Read-Only Memory (EEPROM)), power source 208, push switch 210, localized feedback mechanism 212 and sensor suite 214, which can include one or more sensors (shown in FIG. 7 as a vibration sensor 216, temperature sensor 218 and strain sensor 220). The sensor node is attachable to an implement on a rotating shaft or on a rigid member of a structure. In addition, the push switch 210 on the sensor node can be activated by a user to cause the sensor to receive feedback about a condition of the implement or structure. When not in use, the sensor node can be placed into a sleep cycle to conserve power until reactivation is desired (e.g., by the user once again pushes the switch 208 to activate the sensor node).

The device works in a similar fashion when attached to a rigid member of a structure. The device is attached to an appropriate place on the member such that the onboard sensors can detect the data that is required. The power source 210 powers these sensors which return analog signals that are digitized by the converter 204 and are then sent onto the processor 202 for further processing. The processor 202 utilizes the converted signals and utilizes a finite element analysis (FEA) or experimentally produced comparison table to provide feedback 212 on whether the device is inside or outside predetermined limits.

In accordance with one aspect of the present invention, the sensor node device can be installed or located in an appropriate place on an implement that will experience strain as it is installed on a shaft. To accomplish this, the power source 210 supplies an excitation current to the strain sensor 220 to measure strain as an implement is tightened on the shaft. During manufacture, the device has a zero strain reference that is stored in onboard memory to zero out any residual stresses. When the underlying material is strained, the electrical input from the strain gage enters the ADC 204, after which the digital signal is fed to the processor 202. In addition to the strain sensor 220, the sensor suite 214 can be configured such that other physical conditions or operating performances exhibited by the structure are also measured. For instance, a thermal sensor 218 can be incorporated to measure the temperature, and in turn, transmit an analog voltage signal to the ADC 204, which is then converted to a digital signal and fed to the processor 202 for processing. Through an FEA and experimentally derived algorithm, the processor 202 uses the input to determine stress in the implement and thus pressure applied to the shaft. According to certain aspects of the invention, when the pressure applied to the shaft is below the optimal range, the LED remains lit in the yellow color. Once the shaft pressure reaches the optimal range, the LED turns green. If the pressure applied to the shaft reaches above the optimal range, then the LED turns red.

In embodiments in which a strain gage sensor is used, it should be understood and appreciated herein that selecting the installation site of the strain gage on the implement is an important consideration, particularly as the strain gage should be positioned properly to detect the desired strain levels. For example, and with reference to FIG. 1, the strain gage 102 must be placed in such a way that it reads the desired strain vector in an implement as a proxy for pressure exerted on the shaft. Moreover, the strain gage 102 should be placed such that an average reading of the strain across a section of the implement can be taken, particularly as a point stress concentration would give a false reading. Yet another consideration in the placement of the strain gage 102 is hoop stresses that can create stress concentrations in cylindrical geometries. Taking these factors into consideration, the selection of one strain gage per sensor can be used in certain aspects of the present invention. According to this exemplary embodiment, the strain gage 102 can be coupled with three dummy resistors to form a Wheatstone bridge 104. Multiple sensor nodes will be emplaced around the circumference of the cylinder to ensure proper installation of the implement. As hemispherical loading or hoop stress concentrations become evident, only a subset of the sensors will indicate proper levels of stress. Alternate configurations for the strain sensor are a “half bridge” consisting of two gages (one in tension and one in compression) or a “full bridge” consisting of four strain gages (two each in tension and two each in compression) where the implement geometry allows for broad placement of the gages.

In embodiments utilizing one strain gage (e.g., such as shown in FIG. 1), the Wheatstone bridge 104 feeds two inputs to a differential operational amplifier 106 that will amplify the signal gain by a configurable multiplier and send it to the ADC 204 for digitization according to the following formula:

$$Δ v \approx \frac{BV \times GF \times ɛ}{4}$$

where Δv is the voltage difference; BV is the bridge voltage; GF is the gage factor of the gage (sensitivity to strain) and ε is the strain.

When the gage covered area on the implement is placed under tension, the bridge 104 is unbalanced as the gage side produces a higher resistance, which causes a voltage differential to be sent from the differential op-amp to the processor's ADC 204 for signal conversion. In selecting the voltage and current to send to the gage, an optimal excitation voltage and current is selected based upon the power consumption required to achieve optimal gage sensitivity.

It should be understood and appreciated herein that the geometry of the implement, location of device emplacement, material of the implement, and material of the shaft are various factors that can be considered when trying to correctly calibrate the device. Moreover, gage selection is dependent upon implement material selection, application conditions, expected service life, and other pertinent constraints. Alternative sensors to the strain gage include, but are not limited to, laser, ultrasound, magnetic resonance, electrical, piezoelectric, and nanotubes.

The temperature sensor 108 receives power from the sensor battery source. The battery provides a reference voltage to the processor indicating ambient temperature with a temperature sensor specific formula. As an example, a precision analog output complementary metal-oxide-semiconductor (CMOS) integrated-circuit temperature sensor (such as the LM94022 temperature sensor manufactured by National Semiconductor and shown in FIG. 1) can be used to send an output to the processor per the following equation:

$$V - {V}_{1} = \frac{( {V}_{2} - {V}_{1} )}{( {T}_{2} - {T}_{1} )} * ( T - {T}_{1} )$$

assuming VDD=3V and GS settings=00, and where: V is in mV, T is in ° C., T₁ & V₁ are the lowest values expected and T₂ & V₂ are the highest values expected. The temperature sensor 108 will send the resulting mV output to the processor's ADC for signal conversion and to the processor for analysis and determination of the temperature.

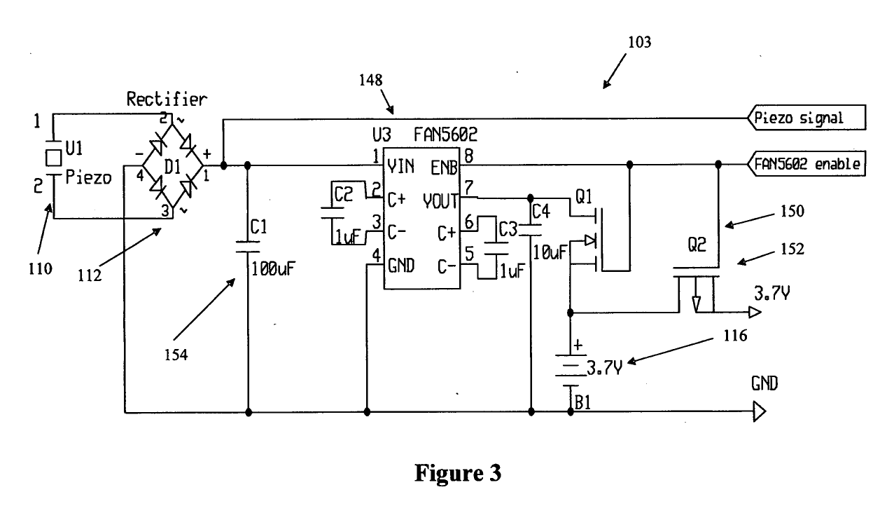

A piezoelectric material 110 (such as shown in FIG. 3) can be utilized as an accelerometer to measure vibration or seismic activity in the implement. These signals are sent as raw signals to the processor's ADC and are processed before appropriate commands are executed. In addition to utilizing the piezoelectric material 110 for its ability to detect vibration (accelerometer properties), the material also produces a current at a strain and vibration level to recharge the secondary battery. The AC current produced is then converted to a DC current by a rectifier 112.

According to certain aspects of the present invention, a primary lithium cell (3V) 114 and/or a rechargeable Li-ion button cell (3.7V) 116, 118 and 120 (as shown in FIGS. 3, 4 and 5, respectively) can be used as the power source, particularly as these power sources have superior charge density, voltage linearity, and relative high voltage as compared to other battery technology. Whatever power source is chosen for the specific application, the capacitor collects the charge from the power collecting techniques and recharges the battery through a recharge circuit.

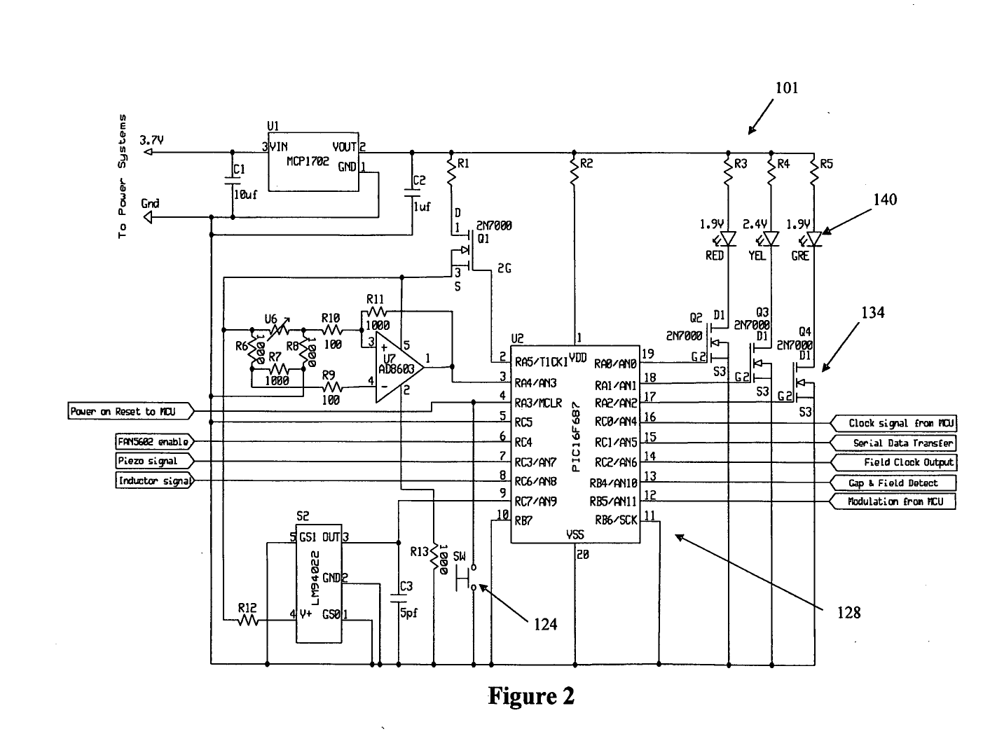

With respect to the push switch 208, in certain exemplary embodiments, a momentary push switch (such as shown in FIGS. 1 and 2 and labeled with reference numerals 122, 124, respectively) can be used to activate the processor's reset option, which in turn brings the device from a sleep mode to an active mode for a period-of-time and starts recording data on the onboard memory. If no activity is detected during the processor's active period, it is placed back into sleep mode. It should be understood and appreciated herein that the devices of the present invention may be activated or awaken by various components and/or conditions. For instance, in certain embodiments, the device may be activated by a timer or a radio transmission, while in other embodiments, the device may be activated by a physical condition. As such, those of skill in the art should understand and appreciate that the present teachings are not intended to be limited to the specific illustrations shown herein.

Various different processors 202 can be used in accordance with the teachings of the present invention. For instance, in certain exemplary embodiments, a 20-Pin Flash-Based 8-Bit CMOS microcontroller, such as the PIC16F687 Low Pin-count (20) PIC® Flash microcontroller (shown in FIGS. 1, 2 and 6 as reference numerals 126, 128 and 130, respectively) manufactured by Microchip Technology, Inc. As should be understood and appreciated by those of skill within the relevant art, the processor 202 is intended to serve as the “brains” of the sensor and has both a hardware and software component to its operation. Factors that can be considered when selecting a processor 202 include, but are not limited to, power consumption, clocking, ADC capabilities, number and type of input pins, and number and type of output pins. Key operations of the processor include, but are not limited to, clock functionality, V_{ref}, multi-channel analog digital signal converter (ADC), data processing, data capture via onboard/external memory, LED control and power and Power-On-Reset (POR).

The clock is configured to provide frequency for signal, data capture, data evaluation, and resulting output. According to certain aspects of the present invention, a frequency of 31 KHz internal clock is sufficient to drive sampling of signals from the device's sensors, manage power consumption, and drive the LED display. An external oscillator can also be used to drive the sensor.

V_{ref} can be used to compare the voltage value for the temperature sensor, compare the voltage value for the strain gage and/or to compare voltage values for any additional sensors. In certain embodiments, V_{dd} is used as V_{ref}, while in other embodiments a sample of V_{ref} is taken from the sensor circuit.

The multi-channel ADC function of the processor 202 is useful for receiving the sensors' input and converting it to a digital signal that is analyzed and converted, via programming, into a proxy for the torque of the implement on the shaft. This analysis and programming drives the input for the LED to show the “state” of the implement shaft torque. To this end, it is useful to calculate the same V_{ref} for all sensors and to ensure that the voltage is maintained and programmed across all sensors to make proper comparisons. The ADC 204 utilizes channel toggling to ensure that the proper signal is logged into the processor 202 under the correct sensor while the signal sample capacitor is used to reduce sensor noise. Lastly it is also useful to ensure that proper software testing and debugging has occurred so that the analog signals are being properly received and the appropriate signal sent to the LED.

The data processing function of the processor 202 is responsible for processing the collected data from the ADC 204, comparing the collected data to the preset limits, storing the data in memory, and sending the correct signal to the output display.

With respect to the memory component 206, the onboard Electrically Erasable Programmable Read-Only Memory (EEPROM) is accessed through a special register to write data transferred from the processor 206. The EEPROM memory retains its data, even when power is removed. The EEPROM stores the high & low readings as well as continuous data. In one embodiment, every three program cycles, the earliest data is erased and new data is written to the chip. Additional external memory (e.g., EEPROM, Flash, etc.) can be added for applications requiring precise or short time interval data points.

In certain aspects of the present invention, light emitting diodes (LEDs) act as a display 212 to notify the user when the optimal amount of implement pressure has been applied to the shaft. Through an array of enhanced n-type metal-oxide-semiconductor field-effect transistor (MOSFET) switches (shown in FIGS. 1 and 2 as reference numerals 132 and 134, respectively), the processor 202 controls the power applied to the LED display. Based upon the sensor feedback into the ADC 204, the processor 202 opens the gate and power flows to either the red, green, or yellow LED. If the temperature compensated stress levels are below the specified optimal stress range the processor 202 will activate the yellow LED. Once the stress levels move inside the optimal window, the processor 202 will activate the green LED. If the stress levels are exceeded, the processor 202 will activate the red LED. If the stress levels pass the elastic threshold and enter the plastic deformation range the processor 202 will lock the LED in the red position.

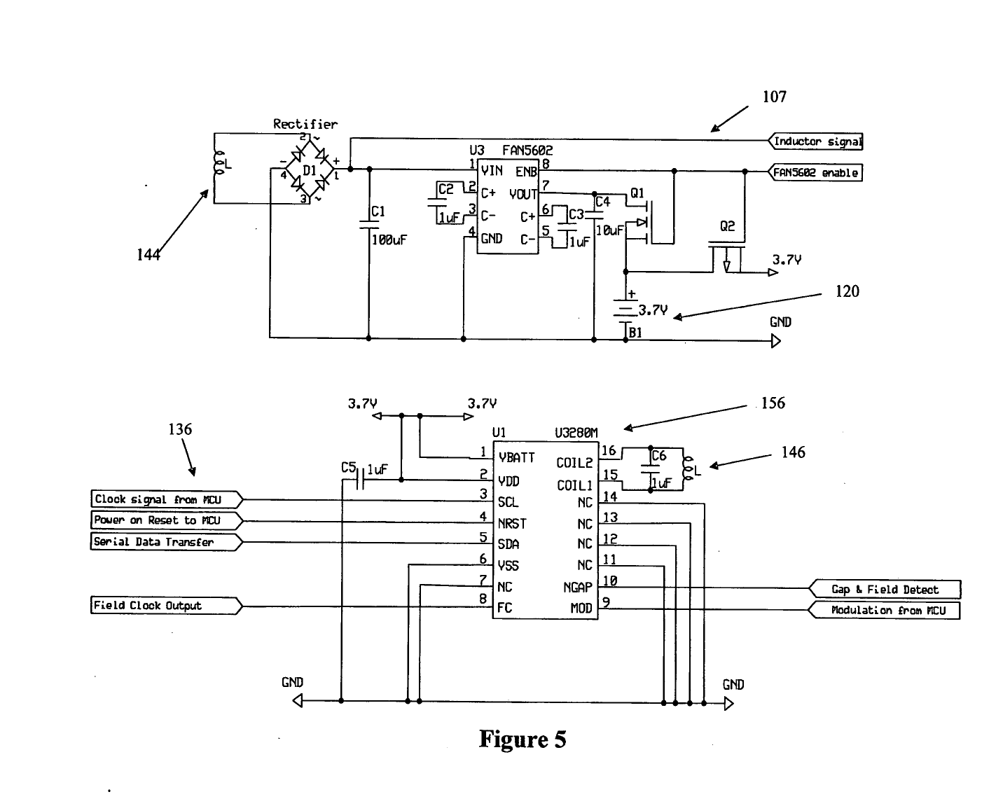

The power-on reset (POR) function of the microprocessor generates a reset signal when power is applied and can also be used to ensure that the device starts operating in a known state. According to this aspect of the present invention, the sensor node is capable of being reset by the switch 208 to wake the processor from its sleep command. The processor can also be woken from sleep by the RFID chip (shown in FIG. 5 as reference numeral 136) as part of the initiation of communication with the base station. If the processor 202 senses a drop in power, it will initiate a Brown-Out Reset until it senses a minimal level of power to operate.

The LED can be a single, or multiple low-power, light emitting diode (shown in FIGS. 1 and 2 as reference numerals 138 and 140, respectively) that displays the status of the implement sensed data (e.g. applied pressure on the shaft based upon the signal sent from the processor). Other output methodologies useful in accordance with the present teachings can include visual (e.g., LCD, OLED, color or shape changing material driven by an electrical signal), auditory (e.g., beep, siren, whistle), and tactile (e.g., “turkey” pop-up, lengthening bar, Braille like bumps).

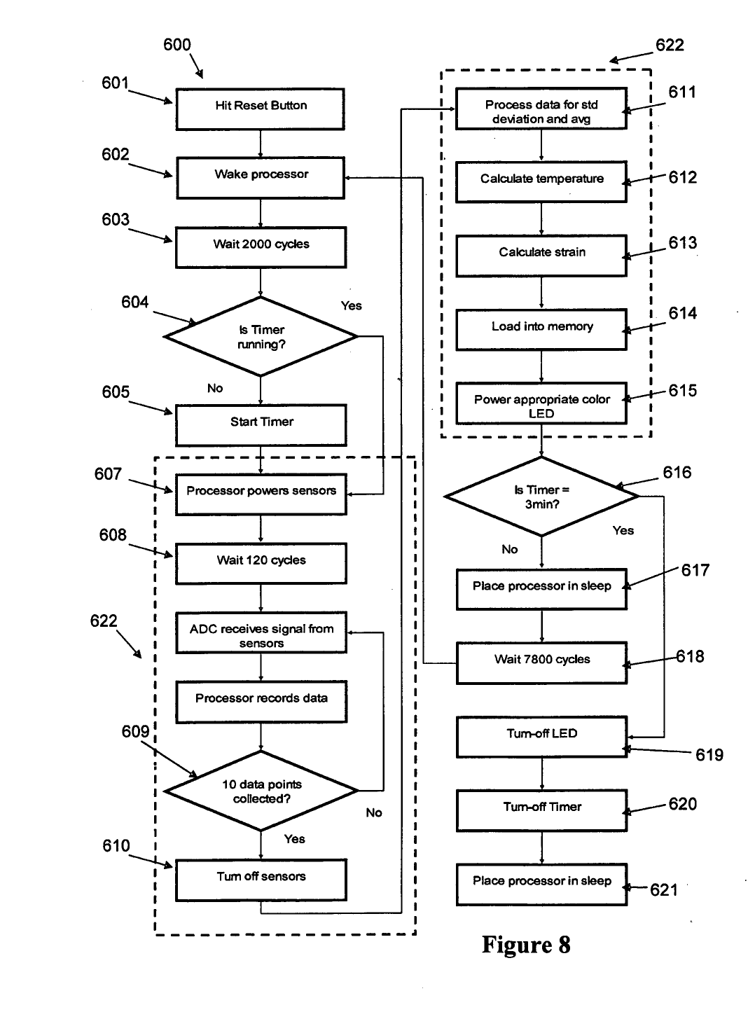

FIG. 8 illustrates an operational flowchart for a first sensor node embodiment in accordance with the teachings of the present invention. According to this embodiment, the basic sensor is activated via the push switch 122 or “reset button” 601, which causes the processor 126 to switch to an active mode 602. The processor 126 waits for several clock cycles (e.g., 2000 clock cycles in specific exemplary embodiments) as it awaits stabilization of its internal circuitry 603. The processor 126 checks to see if its watchdog timer is active 604. If the watchdog timer is not active, then the processor 126 activates the watchdog timer 605. Once the processor 126 is powered and the timer active, the processor 126 powers 607 the sensor suite via the metal-oxide-semiconductor field-effect transistor switch (e.g., MOSFET Q1) 606. The processor 126 waits 120 clock cycles while the sensors stabilize 608. Following this wait period, the processor collects 10 samples (10 samples each for both strain and temperature) from the ADC 609 during 500 clock cycles. After the 10 data points are collected, the processor deactivates MOSFET Q1 606 which discontinues power to the sensor suite 610. The 10 data points are averaged in order to reduce system noise and their standard deviation is taken in order to flag erroneous data 611. The processor 126 uses the average of the sample to calculate the temperature 612 using the following equation:

$$V - {V}_{1} = \frac{( {V}_{2} - {V}_{1} )}{( {T}_{2} - {T}_{1} )} * ( T - {T}_{1} )$$

assuming VDD=3V and GS settings=00, and where: V is in mV, T is in ° C., T₁ & V₁ are the lowest values expected and T₂ & V₂ are the highest values expected. Then the strain 613 is calculated according to the following formula:

$$Δ v \approx \frac{BV \times GF \times ɛ}{4}$$

where Δv is the voltage difference; BV is the bridge voltage; GF is the gage factor of the gage (sensitivity to strain) and E is the strain. The processor 126 can then load both of these data points into EEPROM memory 614 if it is desirable to store the information for later retrieval. The processor compares these data points to a predetermined lookup table (developed using FEA analysis of the application) to determine the temperature compensated strain. This temperature compensated strain value is compared to pre-programmed lower and upper limits to determine which LED to light 615. Steps 607-615 (which have been generally indicated by reference numeral 622) constitute additional processes (i.e., data acquisition, processing and display processes) that can further be incorporated into more intermediate and advanced sensor embodiments in accordance with the teachings of the present invention if desired. If the value is below the lower limit, then the yellow LED is lit. If the value is between the limits, then the green LED is lit. If the value is above the upper limit, then the red LED is lit. The processor reads the watch dogtimer value to see if three minutes have elapsed 616. If three minutes have not elapsed, then the processor is placed in sleep 617 mode and re-awakes after 7800 clock cycles 618. If three minutes have elapsed, then the active LED is turned off 619, the watchdog timer is turned off 620, and the processor is placed in sleep mode 621. While the clock cycle of this exemplary embodiment is dependent upon a 31 kHz internal clock, it should be appreciated and understood herein that the clock cycle is dependent upon the speed of the clock. As such, it should be appreciated that if the speed of the clock is altered in certain exemplary embodiments, the clock cycle will change in response thereto.

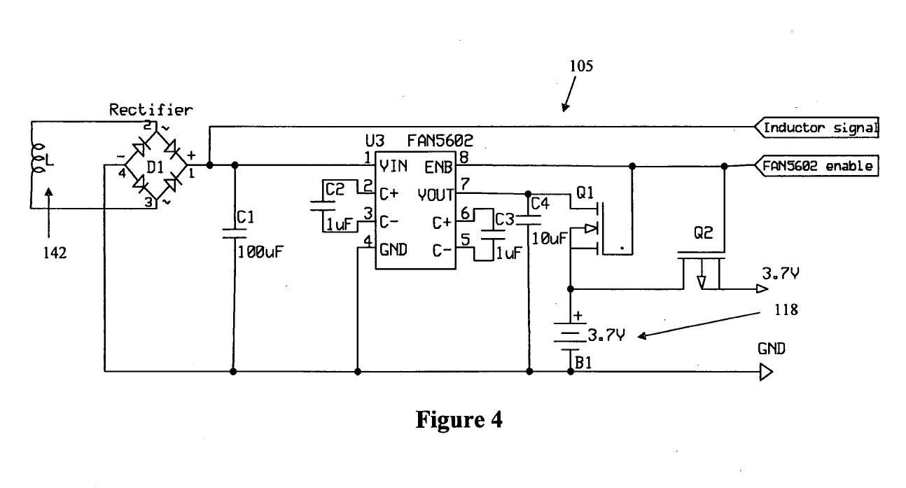

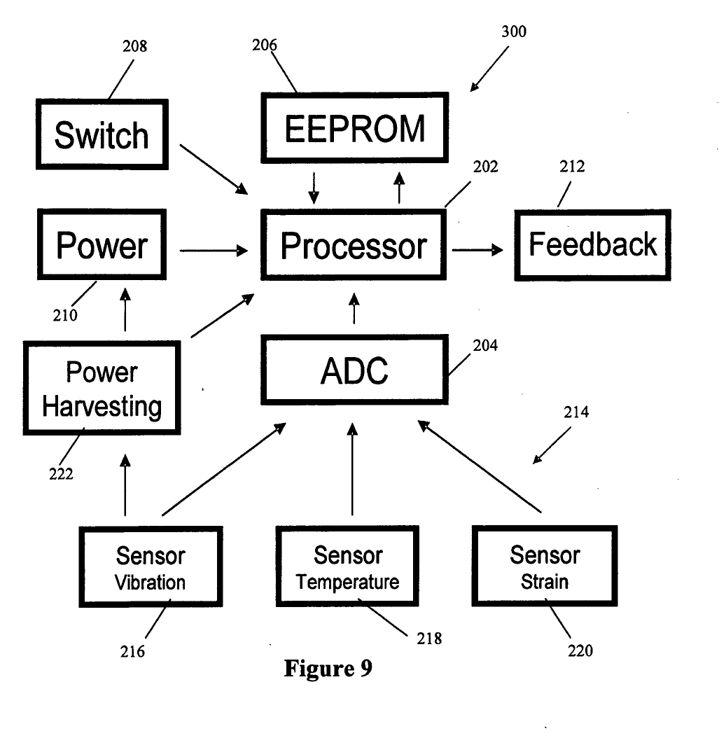

FIG. 2 illustrates an electrical circuit diagram 101 for a second sensor node embodiment in accordance with the teachings of the present invention is illustrated. Moreover, FIG. 9 illustrates an operational schematic for the second sensor node embodiment. According to this exemplary embodiment, all the basic components shown in the illustrative embodiment of FIG. 1 are included; however, the embodiment further incorporates a power collection capability to the design. As such, the sensor node includes a processor 202, converter 204 (such as an analog digital converter (ADC)), memory 206 (such as Electrically Erasable Programmable Read-Only Memory (EEPROM)), power source 208, push switch 210, localized feedback mechanism 212, sensor suite 214, which can include one or more sensors (shown in FIG. 9 as a vibration sensor 216, temperature sensor 218 and strain sensor 220), and ambient power collecting circuit (PCC) 222. According to this embodiment, ambient power is collected via a number of different methodologies and recharged by an onboard rechargeable power supply. Exemplary illustrations of such methodologies usable in accordance with this exemplary embodiment are shown, for example, in FIG. 3, which depicts a power collection circuit utilizing ambient pressure to generate power through a piezoelectric material, as well as FIG. 4, which depicts a power collection circuit utilizing ambient kinetic energy to generate power through an inductive system (e.g., a coil and magnetic field). With respect to these embodiments, the sensor node is adapted to provide continuous feedback on the state of the implement or structure since it is capable of renewing its power source.

Power collecting techniques have traditionally been mechanically oriented and focused on transforming ambient power into mechanical power (e.g., waterwheel or windmill). In recent years, power collecting techniques have been developed to provide power to low powered integrated circuit applications where it is not feasible or convenient to replenish power sources. These devices can collect power depending on their surrounding environment utilizing an arsenal of onboard devices. Examples include, but are not limited to, piezoelectric materials, which produce a voltage proportional to applied dynamic forces (See, for example, reference numeral 110 in FIG. 3), coil(s) and permanent magnets, which produce a current proportional to the change in applied magnetic field (See, for example, reference numeral 142 in FIG. 4), RFID, which captures the energy in a radio signal via a coil (See, for example, reference numerals 144, 146 in FIG. 5), thermoelectric power collection, which takes advantage of a thermal gradient between two thermal electrically different metals, pyroelectric materials, which take advantage of the ferroelectric properties of a material to generate electricity and photovoltaic materials, which take advantage of ambient light sources to generate electricity.

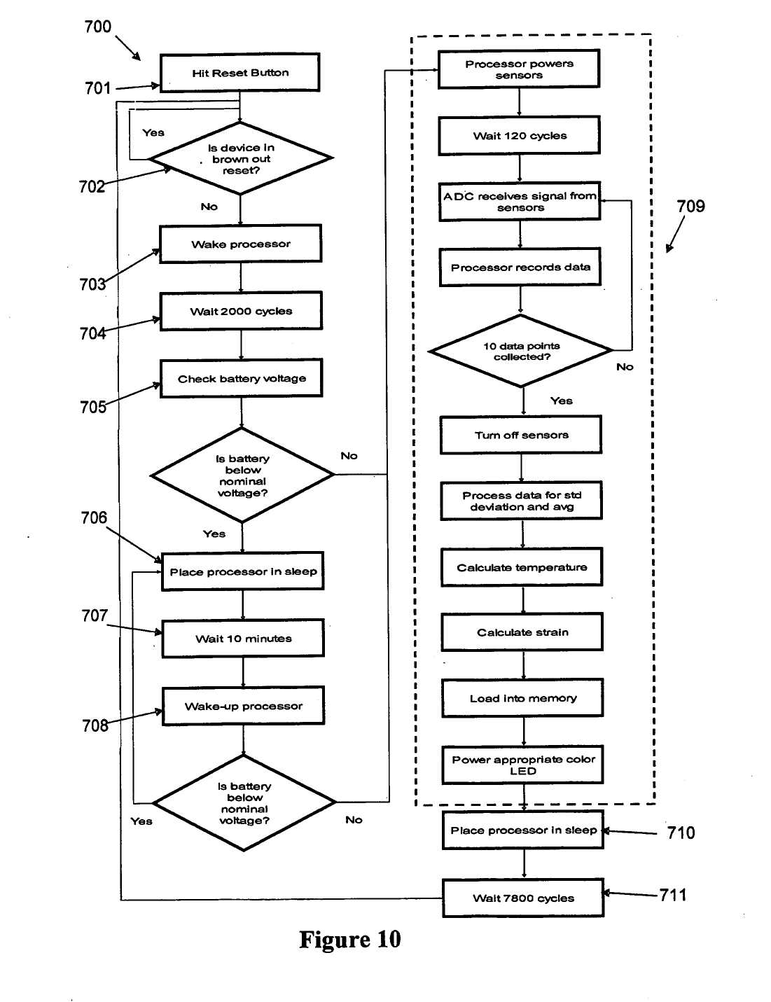

FIG. 10 illustrates an operational flowchart for a second sensor node embodiment 700 in accordance with the teachings of the present invention. According to this exemplary embodiment, the intermediate sensor is activated by the switch 122 or “reset button” 701. If the processor is in a brown-out reset 702 (i.e. voltage is lower than operational requirements), it will not activate. If the processor is not in brown-out reset, then the processor is switched to active mode 703. The processor waits 2000 clock cycles 704 to stabilize and then compares the battery voltage to an internal reference 705. If the battery voltage is below its nominal operating voltage (derived experimentally), then the processor is placed in sleep mode 706 for 10 minutes 707 using the continuously running watchdog timer. Once the sleep period has elapsed the processor is switched to active mode 708 and it checks to see if the battery has been charged by the energy harvesting circuit(s) (i.e. the voltage has increased above nominal). If the voltage has not increased, the processor is placed back in sleep mode 706 and the cycle is repeated. If the battery is above nominal voltage, then additional steps generally indicated by reference numeral 709 can be performed. It should be understood and appreciated herein that these steps are equivalent to the steps described above with respect to steps 607-615 of FIG. 8 and not described again for simplicity purposes. Once the LED is activated, the processor is placed back into sleep mode 710 for 7800 clock cycles 711 (watchdog timer) and the nominal battery check begins again. While the clock cycle of this exemplary embodiment is dependent upon a 31 kHz internal clock, it should be appreciated and understood herein that the clock cycle is dependent upon the speed of the clock. As such, it should be appreciated that if the speed of the clock is altered in certain exemplary embodiments, the clock cycle will change in response thereto.

FIG. 3 shows an electrical circuit diagram for a power collection circuit 103 embodiment utilizing piezoelectric power gathered from an environment in accordance with the teachings of the present invention. According to this exemplary illustration, the piezoelectric material develops a voltage differential and flowing AC current (when the circuit is complete) that is dependent upon the dynamic forces that are applied to the piezoelectric material. The resultant AC current is converted to a DC current by a full bridge rectifier 114 and stored in a large capacitance capacitor. A DC-DC converter 148 (such as the FAN5602 universal switched capacitor DC/DC converter manufactured by Fairchild Semiconductor, Inc.) steps-up or steps-down the applied capacitor voltage to 4.2V when the chip is activated. The processor sets the DC-DC converter enable signal to high when it detects that sufficient charge has developed in the capacitor and that the battery is operating below nominal voltage. The high DC-DC converter enable signal opens the Q1 MOSFET 150 and closes the Q2 MOSFET 152 allowing the battery to charge for about 320 microseconds. If the battery is not completely charged and the capacitor C1154 has charge left, the cycle will repeat.

FIG. 4 illustrates an electrical circuit diagram for a power collection circuit embodiment utilizing inductor based power gathered from an environment in accordance with the teachings of the present invention. The inductor power collecting circuit 105 has one or more permanent magnets emplaced within proximity to the sensor node, which has been attached to the implement on a rotating shaft. As the implement rotates on the shaft, the coil 142 is pulled through the magnet(s) magnetic field, driving an AC current through the coil. The AC current is converted to a DC current and drives the DC-DC converter per the above illustrative example.

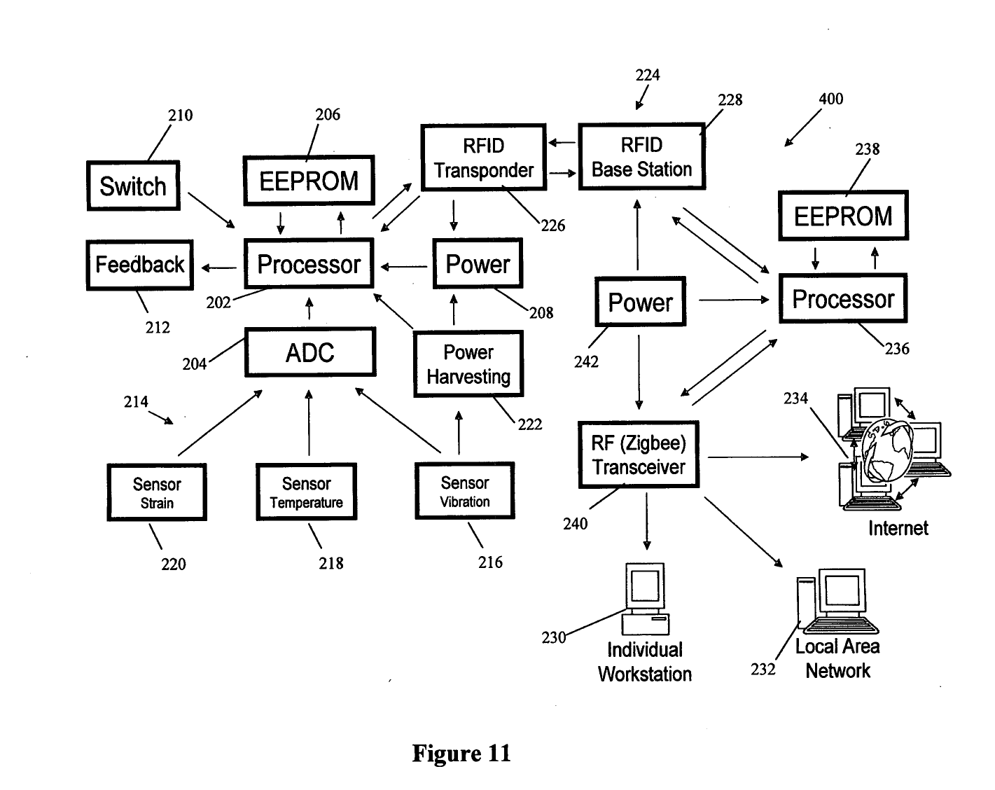

FIG. 5 illustrates an electrical circuit diagram for power collection circuit embodiment 107, which utilizes radio frequency identification (RFID) power that has been gathered from an environment. Moreover, FIG. 11 illustrates an operational schematic 400 for this illustrative embodiment. This embodiment includes all the basic components shown in the illustrative embodiments of FIGS. 1 and 2, yet further incorporates a remote reporting capability to the sensor node. As such, the sensor node includes a processor 202, converter 204 (such as an analog digital converter (ADC)), memory 206 (such as Electrically Erasable Programmable Read-Only Memory (EEPROM)), power source 208, push switch 210, localized feedback mechanism 212, sensor suite 214, which can include one or more sensors (shown in FIG. 11 as a vibration sensor 216, temperature sensor 218 and strain sensor 220), power harvesting collecting circuit 222, and remote reporting component 224. According to this embodiment, a RFID transponder 226 is associated with the sensor node to communicate remotely with the base station 228. The RFID base station 228 and a radio frequency (RF) transceiver 226 are incorporated into a base station to transfer data (e.g., via satellite, cellular, or radio networks) related to the implement or structure from the sensor node to a remote location, such as a workstation 230, local area network (LAN) 232, or Internet 234. More particularly, when the sensor node is combined with an RFID element and base station, the feedback is not only transmitted via the visual feedback, but is remotely transmitted via radio transceiver to an individual base station, local area network or internet hub. The base station initiates contact with the sensor node and also provides a source of energy to the node via its radio wavelength radiation. The sensor node transmits data at a rate the base station queries. One base station can receive input from multiple sensor nodes. It should be understood and appreciated herein that the devices of the present invention can work with any type of wireless technologies, including but not limited to, Bluetooth, Wi-Fi, and ZigBee to transmit data. Additionally, power collection circuits can be integrated into the various embodiments of the present invention such that they are continuously powered.

The radio frequency identification (RFID) transponder 226 collects power in a similar way to the above examples with two notable differences. First, the RFID power collection circuit collects power from electromagnetic energy in radio signals via a set of coils (see, for example, reference numerals 144 and 146 in FIG. 5). Second, the power collected from the radio signals powers two circuits; one circuit stores the collected power and stores it in a capacitor similar to the above examples. The second circuit powers the RFID transponder 226 and enables communication between the processor 236 and the base station 228.

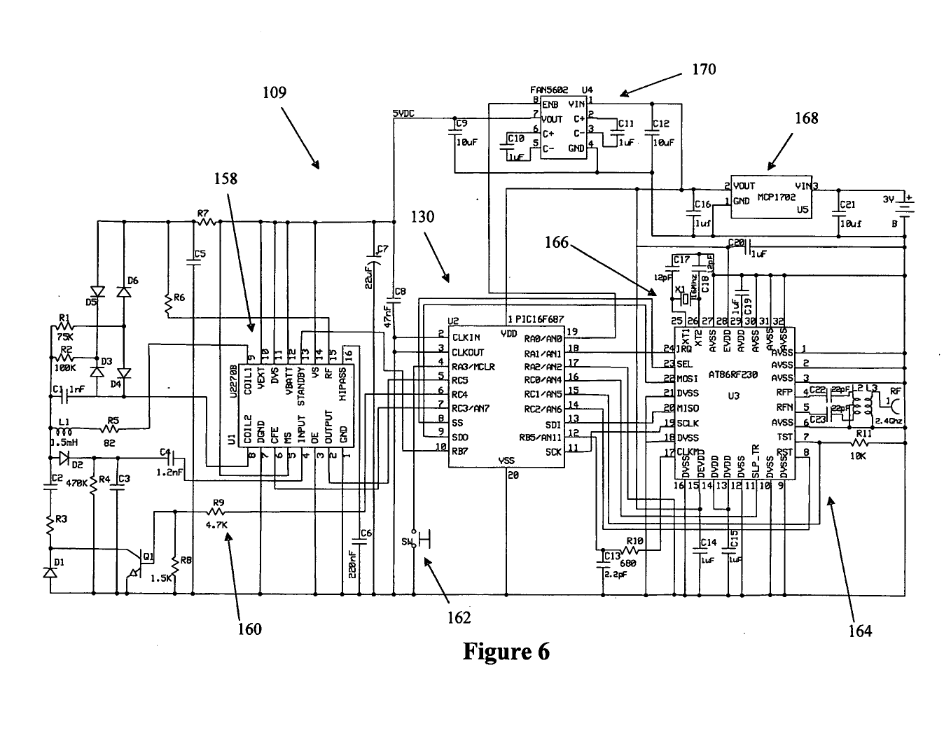

In certain aspects in accordance with the present teachings, the RFID transponder 226 (and shown in FIG. 5 as reference numeral 156) is used for communicating with the RFID base station 228 to open lines of communication to the remote feedback location, communicating with the sensor node processor 202 to initiate wake-up and data transfer protocols and providing power 242 to the PCC. The transponder 226 starts these tasks by receiving communication from the base station 228. The transponder 226 has the capability to modulate its frequency from about 100 kHz to about 150 kHz. According to certain aspects of the present invention, 125 kHz is the standard modulation. The modular input (MOD pin) will be lest in a high state when the transponder 226 is placed in sleep to facilitate wake-up and maximize the power transmission at V_{dd}. The transponder 226 then determines whether the processor 202 is in a Brown-Out Reset, in sleep mode, or in active mode. If the transponder 226 is receiving a clock signal from the processor 202, then it is active and the transponder 226 sends an interrupt signal through the NRST pin (shown as reference numeral 136 in FIG. 5, for example). If the transponder 226 does not receive a clock signal, then it sends a wake-up signal through the NGAP pin. If no acknowledgement is received within 220 cycles, the processor 202 is in Brown-Out Reset (See, for example, FIG. 6) and the transponder 226 communicates the processor's state to the base station 228. Once the processor 202 has been awoken or interrupted, it will transfer the last 3 time stamped cycles of data to the transponder via the serial interface where the SCL pin is used to clock the data and the SDA pin actually transfers the data for upload into the transponder's EEPROM memory. The transponder will then transmit the data stores in memory to the base station. Lastly, the transponder will place itself back in sleep mode.

FIG. 6 illustrates an electrical circuit diagram for a sensor node and base station embodiment 109 in accordance with the teachings of the present invention. The RFID base station 228 (for example, the U2270B read/base station, which is an IC for IDIC® read/write base stations in contactless identification and immobilizer systems and shown as reference numeral 158 in FIG. 6) enables secure communication with the sensor node, transfers implement or member data from the sensor node to the base station processor 236, and provides power to the RFID transponder 226 through electromagnetic energy it transmits (radio waves). The base station 228 initiates communication with the transponder 226 after it has been awoken by the base station processor 2236 via pin STANDBY (See, for example, FIG. 6). The base station 228 can modulate its signal from about 100 kHz to about 150 kHz. In certain aspects in accordance with the present teachings, the base station 228 can modulate its signal at about 125 kHz. The base station 228 utilizes an extended modulation circuit (shown as reference numeral 160 in FIG. 6) that the base station processor controls, should it need to extend its range by increasing or decreasing the modulation. The base station 228 transfers the data received from the RFID transponder 226 via the OUTPUT pin and enabled by setting the OE pin to a low state. The base station 228 is placed in sleep mode by the processor by setting STANDBY to a low state.

The base station processor 236 is configured to wake the RFID base station 228 to initiate communications with the RFID transponder 226, as well as modulate the frequency of the base station's transmission to the transponder. The base station processor 236 also receives the sensor node data from the base station 228, places the base station in sleep mode, wakes the Radio Frequency Transceiver, transfers the data to the transceiver and places the transceiver in sleep mode. The processor 236 utilizes an internal 31 kHz clock to maintain time whether in active or sleep modes. The processor 236 also features a reset switch (such as reference numeral 162 in FIG. 6), which can be activated by the user to reset the base station if there be an operative interruption.

In certain embodiments of the present invention, the base station processor 236 initiates a wake-up command to the RFID base station 228 every 7800 cycles. After the RFID base station 228 receives the sensor data from the RFID transponder 226, it transmits the data to the processor 236 via the RC3 pin. The data is placed in EEPROM memory 238 and is transmitted to the RF transceiver 240 via the processors serial pins. To this end, SS is the slave select pin which is left in a low state to allow communication with the slave serial interface on the RF transceiver 240, SDO is serial data out and transmits data from the processor to the RF transceiver 240, SDI is serial data in and transmits data from the RF transceiver 240 to the base station processor 236, and SCK is the serial clock signal from the processor to the transceiver that enables clocking of the signals between the two devices. Once the base station processor 236 verifies that the RF transceiver 240 has transmitted the data, it places the RF transceiver 240 in sleep mode and then places itself in sleep mode, and starts the cycle anew (See, for example, FIG. 6).

The RF transceiver 240 (such as an AT86RF230 low-power 2.4 GHz radio transceiver manufactured by Atmel and shown as reference numeral 164 in FIG. 6) utilizes the IEEE 802.15.4 Zigbee standard to communicate with remote locations utilizing a 2.4 GHz signal to communicate. Due to the higher frequency, this unit has the ability to transmit hundreds of meters and is sufficiently powered to broadcast to ZigBee equipped individual workstations, local area networks, or internet hubs. The RF transceiver 240 receives a wake-up command from the base station processor 236 via its SLP_TR pin. It utilizes a 16 MHz oscillating crystal (such as shown as reference numeral 166 in FIG. 6) to drive its internal clock requirements to transmit data via a coil and antenna configuration on pins RFP and RFN.

The RF transceiver 240 receives data from the base station processor 236 via its serial peripheral interface (SPI) where a low state on the SEL pin denotes it is the slave component, the MOSI (master output slave input) pin receives data from the base station processor 236, the MISO (master input slave output) sends data to the base station processor 236, and the SCLK is the micro processor clock signal that is transmitted to the RF transceiver 240 for clocking of signal between the two devices. Should the RF transceiver 240 be unresponsive, or there is a misalignment in clocked data, the processor 236 can send a reset command to the RF transceiver 240 via the RST pin. Conversely, should the RF transceiver 240 not receive the data it is expecting or the data is corrupted, it can send an interrupt to the base station processor 236, such that the processor will resend the data. The RF transceiver 240 is placed in a sleep state once it transmits its data to the remote location.

According to certain aspects of the present invention, the base station 228 is powered by a primary Lithium battery that is regulated by a low drop out (LDO) regulator (such as the MCP1702 250 mA Low Quiescent Current LDO Regulator manufactured by Microchip Technology and shown as reference numeral 168 in FIG. 6). The regulator provides a stabilized 3V source of power to the RF transceiver 140 and the base station processor 236. The RFID base station 228 requires a stabilized 5V source of power 242 to operate, therefore the regulator, also feeds a DC-DC charge-pump converter (such as reference numeral 170 in FIG. 6) that provides a regulated 5V power source for the RFID base station 228. The battery can be replaced once it has depleted its power via an access port in the base station. It should be understood and appreciated herein that the base station can be powered by a number of different energy sources, including but not limited to, other battery technologies, ambient power sources and/or hard wired power. As such, the present teachings are not intended to be limited to the various illustrative embodiments specifically disclosed herein.

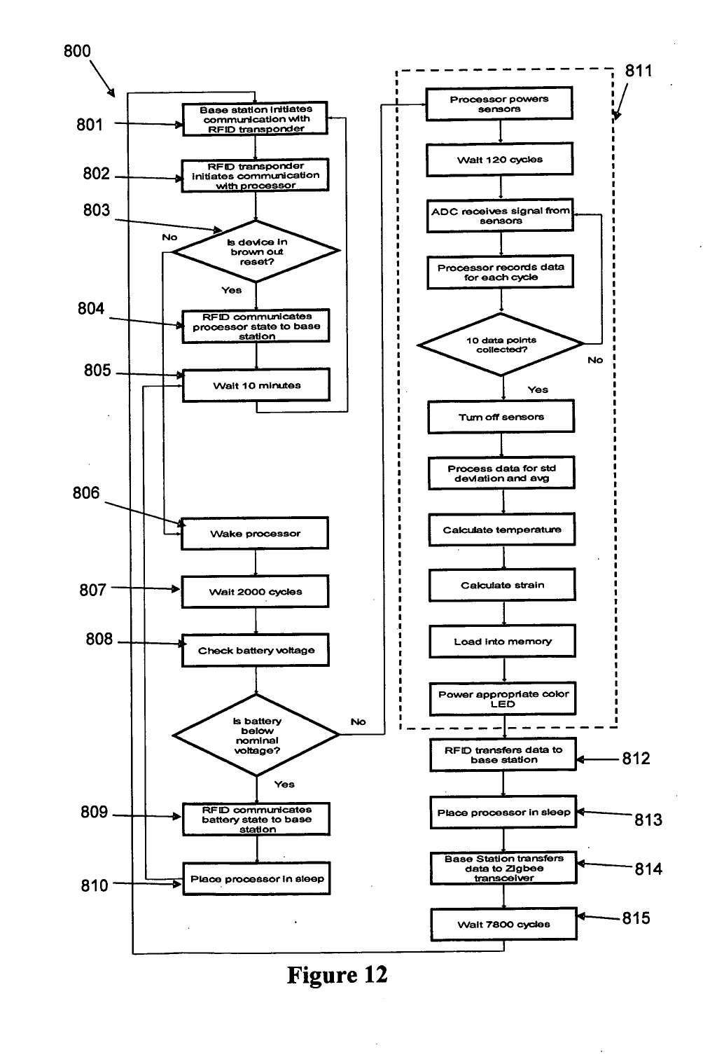

FIG. 12 illustrates an operational flowchart for an advanced sensor node and base station embodiment 800 in accordance with the teachings of the present invention. According to this illustrative embodiment, the advanced sensor is activated by the base station through the advanced sensor's RFID transponder 801. The RFID transponder sends a wake-up command to the processor 802. If the processor is in brown-out reset 803, the RFID transponder communicates the processor state to the base station 804. A 10 minute wait period 805 is initiated by the base station after which the base station initiates communication with the RFID transponder. If the processor is not in a brown-out reset condition, then the processor is switched to active mode 806 and waits 2000 clock cycles 807 for its circuitry to stabilize. The processor compares the battery voltage to an internal reference 808 to determine if the battery is under nominal voltage. If the battery is under nominal voltage, then the RFID communicates the battery state to the base station 809 and the processor is placed into sleep 810 to allow the battery to recharge via the energy harvesting circuitry. After a 10 minute wait period, the base station initiates communication with the RFID transponder again. If the battery is not below nominal voltage, then additional steps generally indicated by reference numeral 811 can be performed. It should be understood and appreciated herein that these steps are equivalent to the steps described above with respect to steps 607-615 of FIG. 8 and not described again for simplicity purposes. Upon completion of this process, the RFID transponder transmits the data to the base station 812. The processor is placed in sleep mode 813, and the base station transfers the data via a Zigbee transceiver 814 (or some other wireless technology) to an individual workstation or network. The base station waits 7800 clock cycles 815 and then re-initiates communication with the RFID transponder. While the clock cycle of this exemplary embodiment is dependent upon a 31 kHz internal clock, it should be appreciated and understood herein that the clock cycle is dependent upon the speed of the clock. As such, it should be appreciated that if the speed of the clock is altered in certain exemplary embodiments, the clock cycle will change in response thereto.

Further advantages and improvements of the devices and associated systems and processes for using the devices in accordance with the present invention are demonstrated in the following descriptive applications. These illustrative applications are descriptive only and are not intended to limit or preclude other variants or aspects of the present invention.

FIG. 13 depicts a sensor node employed on an automotive (e.g., tractor trailer) wheel hub in accordance with the teachings of the present invention. According to this exemplary illustration, the sensor node device 500 is embedded in the wheel assembly 502 in proximity to the wheel lug hole. As the lug nut 504 is tightened on the lug, the lug nut 504 imparts a compressive stress on the wheel face 506. The device 500 detects the compressive stress by way of an embedded strain gauge. Once the compressive strain reaches a predetermined level (e.g. lug area strain approaches about 520 microstrain at 400 ft lbs of torque in 22.5″×9″ wheel), the device 500 displays the green LED to indicate that the wheel is properly secured to the wheel hub 508. If the compressive strain exceeds a predetermined level (e.g. 1700 microstrain), the lug nut 504 has been excessively tightened as has caused possible structural damage to the lug. During wheel operation, vibration from the device 500 can be wirelessly transmitted from the device 500 to the truck cab to alert the driver of a loose wheel or flat tire.

FIG. 14 depicts a sensor node employed on a rail wheel hub in accordance with the teachings of the present invention. According to this exemplary illustration, two sensor node devices 510, 512 are embedded 180 degrees apart in a retaining collar in a rail wheel hub assembly 514. As the retaining collar is affixed to the shaft, the collar experiences compressive stresses as the face of the collar is press fit on the wheel assembly 514. When the devices 510, 512 record a predetermined level of compressive strain, a green LED is displayed to indicate that the retaining collar has been properly installed. Another method used in rail wheel applications in accordance with the present invention is to install a bearing with a lock nut to secure the bearing/wheel assembly to the wheel shaft. In this application, two devices are installed in the lock nut collar 180 degrees apart. As the collar is tightened on the bearing it compresses the bearing inner ring. As additional torque is applied to the bearing lock nut, the compressive strain reaches a pre-determined level, and the device displays that the bearing is properly installed via a green LED.

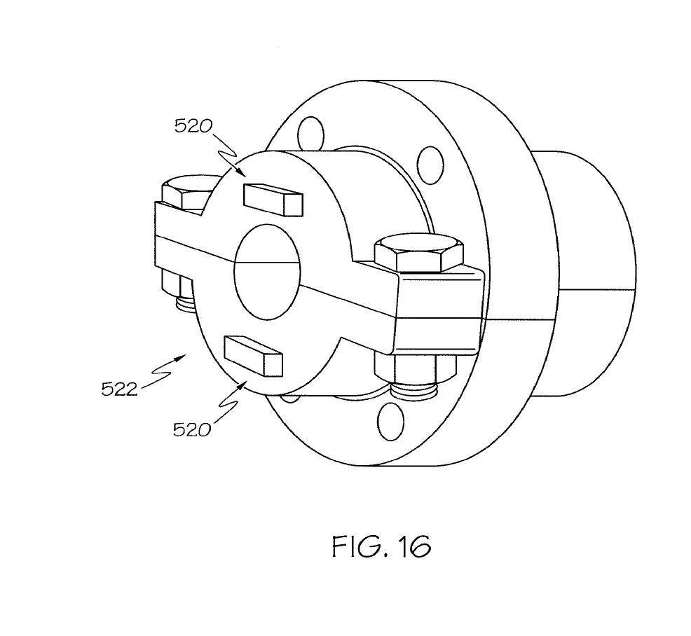

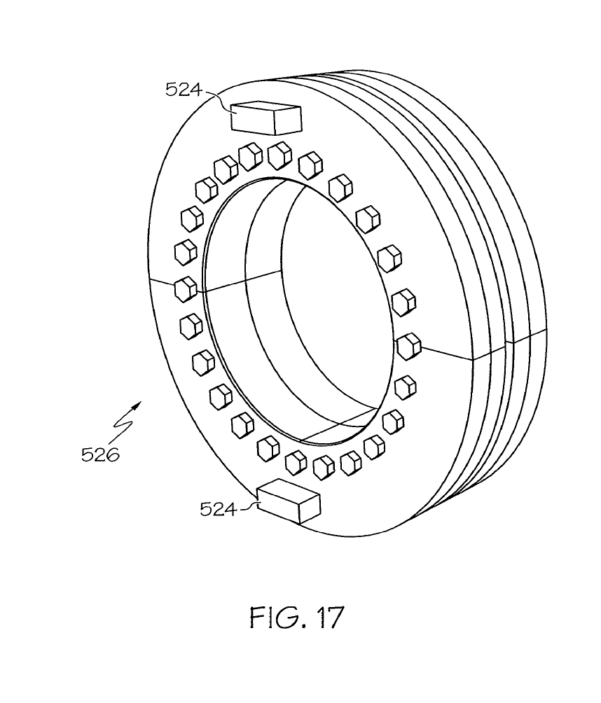

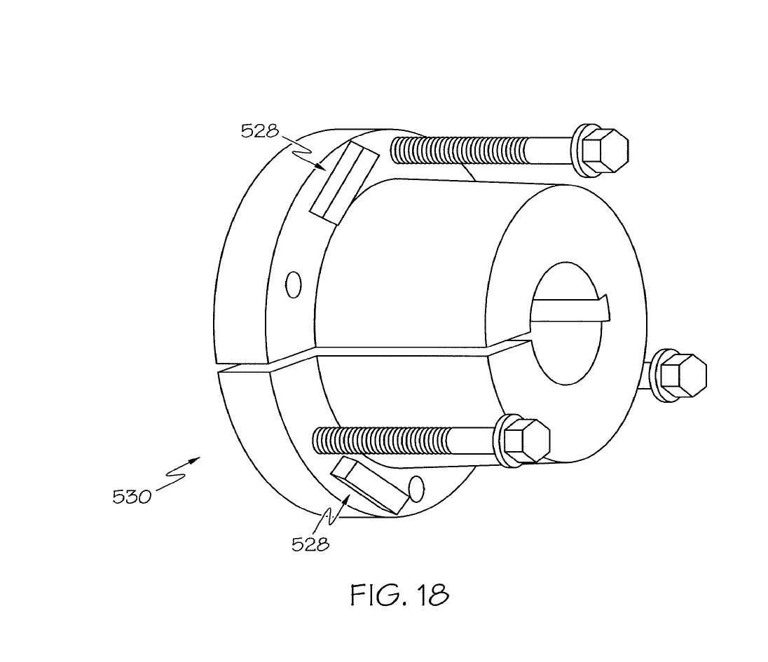

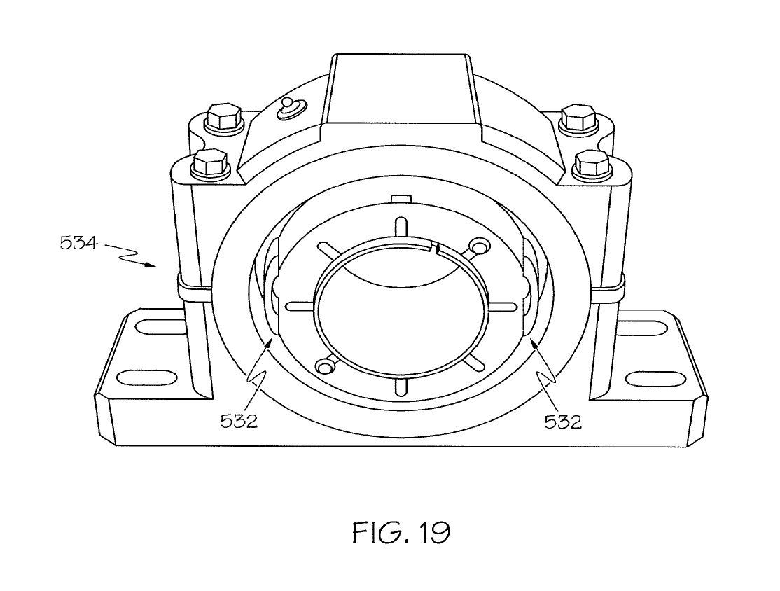

FIGS. 15-19 show sensor nodes employed in further industrial applications in accordance with the present invention. These sensor node devices can be used in multiple configurations, including measuring compression of implement material as it is affixed to a shaft, measuring compression of implement material as a nut or bolt is tightened against the implement face as a proxy for shaft grip, and measuring locknut compressive stress as measure of shaft grip. Specifically, FIG. 15 depicts sensor nodes 516 employed on two types of sprockets 518, FIG. 16 depicts sensor nodes 520 employed on a hub 522, FIG. 17 depicts sensor nodes 524 employed on a shrink disk 526, FIG. 18 depicts sensor nodes 528 employed on a bushing 530, and FIG. 19 depicts sensor nodes 532 employed on a bearing 534.

When affixed to sprockets and hubs, the teachings of the present invention can be used to measure the compressive strain imparted by affixing the split design onto a shaft. At an implement specific predetermined strain level, the device indicates the implement is properly affixed and no further tightening of the connector bolts is required.

The shrink disk 526 depicted in FIG. 17 and bushing 530 depicted in FIG. 18 are similar applications to the previously described wheel hub. The device measures the compressive strain from the lug bolt and nut on the implement face. As the implement face reaches a predetermined strain level, the device displays a green LED to show proper installation.

The bearing application 534 shown in FIG. 19 is similar to the rail wheel hub. More particularly, two devices are embedded 180 degrees apart on a lock nut. Once the locking collar experiences a predetermined compressive strain (588 microstrain in a 2 7/16″ spherical roller bearing), it is considered to be properly installed.

Multiple units are used in the industrial applications to overcome spherical loading effects or ensure proper proximity to the compressive force in order to measure compressive strain.

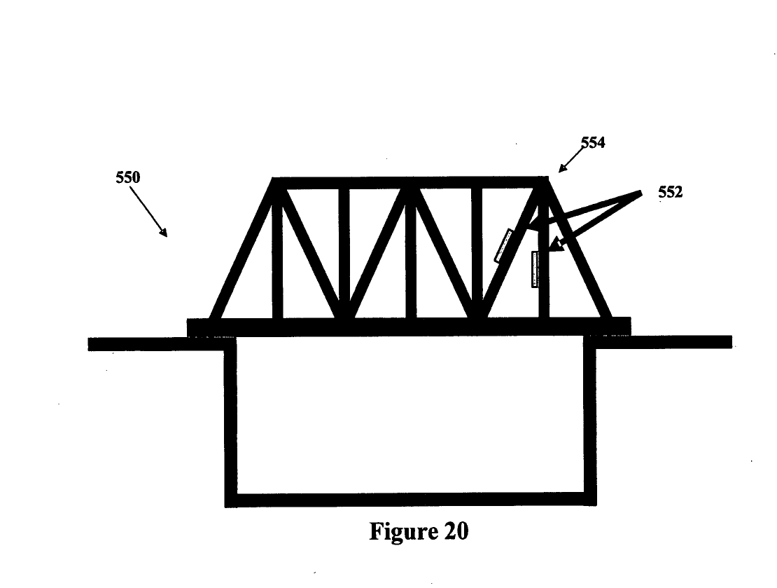

Various illustrative structural applications of the present invention are shown in FIGS. 20-22, where the sensor node devices are used to measure the structural integrity of a member in a larger structure. In the case of a bridge 550 (FIG. 20), the device 552 is embedded in the critical load bearing members of a truss or suspension system 554. When the unit records a strain or vibration reading outside a predetermined parameter, it sends a wireless transmission to a base station connected to the Internet. The data is transmitted to a website where an alarm is displayed to inform the user of the unsafe condition. This system can be integrated into an active system where railroad crossing style gates prevent further entrance to the bridge 550, but allow traffic to depart the bridge structure and thus remove the dynamic load. Additionally, this system can monitor key structural components of a bridge under construction or retrofit to help provide early warning of catastrophic failure. The alarm limits are predetermined using structural modeling techniques.

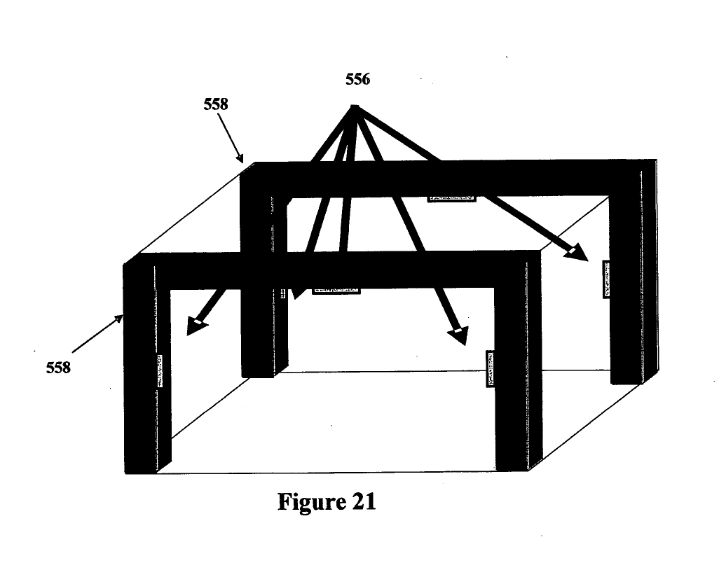

In a mine application (FIG. 21), the device 556 can be embedded into the structural supports 558 that prevent mine collapse. In case a seismic event causes a load shift in the supports outside predetermined limits, an alarm is activated via underground wire. In the event of a mine collapse, the embedded devices can be used to determine the location of the collapsed sections and the likely areas of survivors.

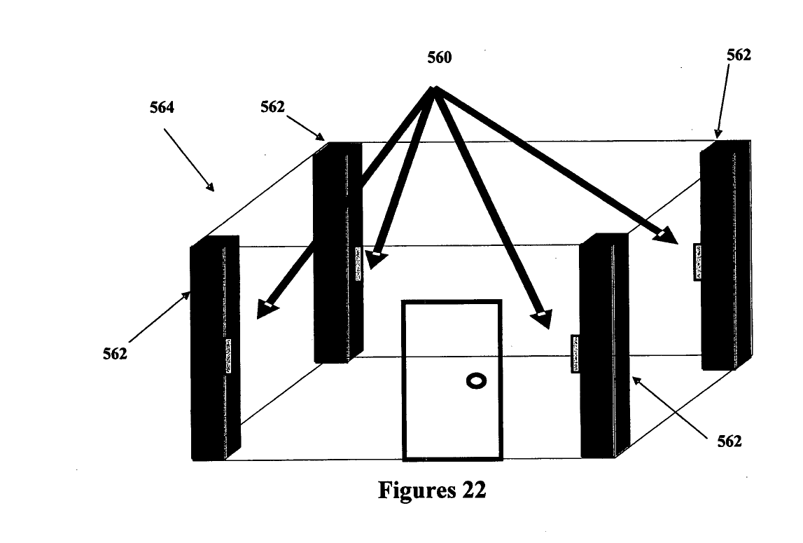

In a building application (FIG. 22), the device 560 is embedded in the load bearing members 562 of the structure 564. In case of a fire in a structure, the embedded devices 560 can transmit stress and temperature data to the fire department via a website. As the fire department arrives on the scene, they can query the website and determine which portions of the structure are compromised, thus assisting in the safe rescue of persons trapped inside. Additionally, the firefighters will have temperature data such that they can fight the hottest portions of the blaze and more efficiently contain the fire. Additionally, the device can be used to monitor other environmental conditions that lead to degraded structural health. By monitoring both vibration and strain, the device can assist emergency response efforts during an earthquake and assist with damage assessment after a seismic event. Additionally, such a configuration can be retrofit into an existing structure to determine the level of structural degradation.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

We claim:

1. A system for monitoring a structure, the system comprising:
at least one sensor node attachable to a structure and configured to monitor a physical condition or operating performance that is being exhibited by the structure;
a power source configured to power the at least one sensor node;
a converter adapted to receive an analog output signal generated by the at least one sensor node in response to the monitored physical condition or operating performance of the structure and to convert the analog signal into a digital signal; and
a processor for receiving the digital signal and processing the digital signal into feedback readable by a user to determine whether the physical condition or operating performance of the structure falls within a predetermined range.

2. The system of claim 1, wherein the power source is selected from at least one of a battery and a capacitor.

3. The system of claim 2, wherein the power source is rechargeable.

4. The system of claim 3, wherein the power source utilizes a power collecting technique to power the at least one sensor node, the power collecting technique being selected from at least one of a piezoelectric material, a coil and permanent magnet, an electromagnetic wave, a thermoelectric device, a pyroelectric device, a photovoltaic system and an air flow system.

5. The system of claim 4, wherein the power collecting technique includes at least one of an electrical power producing material, a rectifier to convert current from AC to DC, a storage circuit to store power, a switching circuit to turn power on and off, and a power regulation circuit to ensure consistent power is delivered to the at least one sensor node.

6. The system of claim 1, wherein the at least one sensor node includes at least one of a strain gage, a temperature sensor, a thermistor, a thermocouple, an accelerometer, an ultrasound device, a laser, a magnetoelastic device, an electrical induction device, a piezoelectrical device, a fiber optic device, and a nanotube device.

7. The system of claim 1, wherein the at least one sensor node is configured to measure at least one of strain, temperature, vibration, pressure, torque, angular rotation, bending, tension, and compression.

8. The system of claim 1, wherein the converter is an integrated analog digital converter.

9. The system of claim 1, further comprising a memory component for storing converted sensor data that has been processed by the processor.

10. The system of claim 9, wherein the memory component contains a unique address to identify the sensor data.

11. The system of claim 10, wherein the memory component further contains a database of previously monitored physical conditions or operating performances of the structure to permit comparison of data, the comparison of data being readable by the user to determine whether the physical condition or operating performance of the structure falls within the predetermined range.

12. The system of claim 1, wherein the processor is adapted to operate in a sleep mode to conserve power, the sleep mode being interruptible by receiving sensor data, by being manually activated via a switch or by being remotely activated by a transceiver network.

13. The system of claim 1, wherein the feedback readable by the user includes a visual indicator, the visual indicator including at least one of a light emitting diode, an LCD, an OLED and a color or shape changing material driven by an electrical signal.

14. The system of claim 1, wherein the feedback readable by the user includes an audible indicator, the audible indicator including at least one of a beep, a siren and a whistle.

15. The system of claim 1, wherein the feedback readable by the user includes a tactile indicator, the tactile indicator including at least one of a turkey pop-up, a lengthening bar and Braille bumps.

16. The system of claim 1, further comprising a radio transducer wirelessly coupled to a base station for transmitting the feedback to one or more remote locations accessible by the user.

17. The system of claim 16, wherein transmitting the feedback includes sending the feedback by a transceiver over a network, the network being selected from at least one of a satellite network, a cellular network and a radio network.

18. The system of claim 16, wherein the one or more remote locations include at least one of an individual workstation, a local area network and the Internet.

19. The system of claim 1, wherein the structure includes a rotatable shaft attachable to a piece of industrial power transmission equipment.

20. The system of claim 1, wherein the structure includes a rotatable shaft attachable to a wheel hub or drive train.

21. The system of claim 16, wherein the base station is located in a vehicle.

22. The system of claim 1, wherein the structure includes a rigid member of a building or structure.

23. The system of claim 22, wherein the rigid member of the building or structure includes at least one of a steel framed building, a bridge span, and an underground mine support.

24. A method for monitoring a structure, the method comprising:
attaching at least one sensor node to a structure;
monitoring a physical condition or operating performance that is being exhibited by the structure with the at least one sensor node;
powering the at least one sensor node with a power source;
generating an analog output signal from the at least one sensor node in response to the monitored physical condition or operating performance of the structure;
converting the analog output signal into a digital signal;
processing the digital signal into feedback readable by a user; and
determining whether the physical condition or operating performance of the structure falls within a predetermined range.

25. The method of claim 24, wherein powering the at least one sensor node comprises powering the at least one sensor node with a power source selected from at least one of a battery and a capacitor.

26. The method of claim 24, further comprising utilizing a power collecting technique to power the at least one sensor node, the power collecting technique being selected from at least one of a piezoelectric material, a coil and permanent magnet, an electromagnetic wave, a thermoelectric device, a pyroelectric device, a photovoltaic system and an air flow system.

27. The method of claim 24, wherein the monitoring step comprises monitoring the physical condition or operating performance being exhibited by the structure with at least one of a strain gage, a temperature sensor, a thermistor, a thermocouple, an accelerometer, an ultrasound device, a laser, a magnetoelastic device, an electrical induction device, a piezoelectrical device, a fiber optic device, and a nanotube device.

28. The method of claim 24, wherein the monitoring step comprises monitoring the physical condition or operating performance being exhibited by the structure to measure at least one of strain, temperature, vibration, pressure, torque, angular rotation, bending, tension, and compression.

29. The method of claim 24, wherein converting the analog output signal into a digital signal comprises converting the signal with an integrated analog digital converter.

30. The method of claim 24, further comprising storing converted sensor data that has been processed by the processor in a memory component.

31. The method of claim 30, further comprising comparing the converted sensor data with a database of previously monitored physical conditions or operating performances exhibited by the structure.

32. The method of claim 24, further comprising operating the processor in a sleep mode to conserve power, the sleep mode being interruptible by receiving sensor data, by being manually activated via a switch or by being remotely activated by a transceiver network.

33. The method of claim 24, further comprising providing the feedback to the user as a visual indicator, the visual indicator including at least one of a light emitting diode, an LCD, an OLED and a color or shape changing material driven by an electrical signal.

34. The method of claim 24, further comprising providing the feedback to the user as an audible indicator, the audible indicator including at least one of a beep, a siren and a whistle.

35. The method of claim 24, further comprising providing the feedback to the user as a tactile indicator, the tactile indicator including at least one of a turkey pop-up, a lengthening bar and Braille bumps.

36. The method of claim 24, further comprising transmitting the feedback to one or more remote locations that are accessible by the user, the transmission occurring by way of a radio transducer that is wirelessly coupled to a base station.

37. The method of claim 36, wherein transmitting the feedback includes sending the feedback by a transceiver over a network, the network being selected from at least one of a satellite network, a cellular network and a radio network.

38. The method of claim 36, wherein the one or more remote locations include at least one of an individual workstation, a local area network and the Internet.

39. The method of claim 24, wherein attaching the at least one sensor node to a structure comprises attaching the at least one sensor node to a rotatable shaft that is attachable to a piece of industrial power transmission equipment.

40. The method of claim 24, wherein attaching the at least one sensor node to a structure comprises attaching the at least one sensor node to a rotatable shaft that is attachable to a wheel hub or drive train.

41. The method of claim 24, wherein attaching the at least one sensor node to a structure comprises attaching the at least one sensor node to a rigid member of a building or structure.

42. The method of claim 41, wherein the rigid member of the building or structure includes at least one of a steel framed building, a bridge span, and an underground mine support.
